(19) United States
(12) Patent Application Publication
(10) Pub. No.: US 2009/0166108 A1
(43) Pub. Date: Jul. 2, 2009

(54) Mobile inverter generator

(75) Inventors: Brian Joseph Gross, Warroad, MN (US); Pearl Albert Wilson, Roseau, MN (US)

Correspondence Address: BAKER & DANIELS LLP, 300 NORTH MERIDIAN STREET, SUITE 2700, INDIANAPOLIS, IN, 46204, US

(73) Assignee: Polaris Industries Inc., Medina, MN (US)

(21) Appl. No.: 11/263,695

(22) Filed: Nov. 1, 2005

(51) Int. Cl. B60K 6/22; B60W 10/06; B60W 20/00

(52) U.S. Cl. 180/65.21; 180/65.28; 180/65.275

(57) ABSTRACT

A vehicle in certain embodiments of the present teachings may include one or more of the following features: (a) a chassis, (b) at least one front ground engaging member and at least one rear ground engaging member coupled to the chassis, (c) a steering member for steering at least one of the ground engaging members, (d) an engine carried by the chassis for powering the vehicle, the engine including a cylinder disposed adjacent a crankshaft and an inverter generator operatively connected to the crankshaft, (e) an output shaft operatively coupled to the crankshaft to transmit power from the engine to at least one of the ground engaging members, and (f) a cover attached to the engine adjacent to the inverter generator, a cooling line disposed within the cover, and a fluid within the cooling line such that heat is transferred from the inverter generator to the fluid.

### FIELD

The present invention relates to the design and construction of an all terrain vehicle (“ATV”). More specifically, the present invention relates to inverter generators on ATVs.

### BACKGROUND

Presently, if an ATV operator desires to operate electrical appliances or devices they must carry a portable generator with them, especially in remote locations. Further, the operator will have to carry other accessories for the generator, such as gas and repair parts. This can be a burden for the ATV operator as it entails lifting a generator, some of which can be very heavy, onto the ATV, strapping the generator down, and strapping all the accessories down. This is a manually intensive process and a time consuming process as well. Further, the generator takes up a lot of space on the ATV. This is space that could be used for other things, such as camping gear, tools, or other desired items. By strapping a heavy generator to the top of the vehicle, the ride and handling characteristics of the vehicle may also be reduced due to altering the center of gravity of the vehicle. Therefore, it is desirable to eliminate the need to carry a portable generator on an ATV to power electrical accessories.

Smaller generators have been implemented into vehicles such as that shown in U.S. Patent Publication 2005/0103553A1 titled, “Component Arrangement for an All Terrain Vehicle”. This publication discusses the issues associated with space constraints in small vehicles, such as ATV's, and discloses a power generation layout in an ATV that incorporates a small 400 Watt generator driven off of the engine crankshaft. This compact generator arrangement provides additional vehicle benefits such as if battery fails; however, it still does not provide enough power generation to operate additional electrical devices similar to those that may be utilized by separate portable generators. Others have also tried to retrofit vehicles by affixing portable generators into portions of the chassis (e.g., front, rear) such that they may be connected directly to the vehicle fuel supply. Although these systems resolve the issues of constantly loading the generators and having to carry additional fuel to operate the generator, they still have a large impact on the vehicle's dynamics and often reduce the amount of vehicle cargo space. Therefore, the need exists for an improved small vehicle engine and generator packaging arrangement that overcomes the problems others have not been able to address.

### SUMMARY

A vehicle in certain embodiments of the present teachings may include one or more of the following features: (a) a chassis, (b) at least one front ground engaging member and at least one rear ground engaging member coupled to the chassis, (c) a steering member for steering at least one of the ground engaging members, (d) an engine carried by the chassis for powering the vehicle, the engine including a cylinder disposed adjacent a crankshaft and an inverter generator operatively connected to the crankshaft, (e) an output shaft operatively coupled to the crankshaft to transmit power from the engine to at least one of the ground engaging members, and (f) a cover attached to the engine adjacent to the inverter generator, a cooling line disposed within the cover, and a fluid within the cooling line such that heat is transferred from the inverter generator to the fluid.

A vehicle in certain embodiments of the present teachings may include one or more of the following features: (a) an engine, (b) a transmission coupled to the engine, (c) at least one ground engaging member, (d) an output shaft selectively coupled to the transmission to transmit power from the engine to the at least one ground engaging member, (e) an inverter generator operatively coupled to the engine to transmit power to an electrical accessory, (f) a control system that selectively controls the speed of the engine in response to the electrical accessory, (g) a control panel including a switch that has a first position and a second position, wherein the control system does not control the speed of the engine when the switch is in the first position, (h) a control panel lid that can be moved between an open and closed position, wherein the switch is automatically moved to the first position when the control panel lid is closed, and (i) a vehicle brake selectively engaged to keep the vehicle in a stationary position, wherein the control system does not control the speed of the engine when the vehicle brake is not engaged.

A method of providing power to electrical accessories from a vehicle in certain embodiments of the present teachings may include one or more of the following steps: (a) placing the vehicle in an inverter generator mode, (b) determining if at least one electrical accessory has been plugged into the vehicle, (c) determining if the load of the at least one electrical accessory has increased, (d) increasing an engine RPM if the load of the electrical accessory has increased, (e) determining if the load of the at least one electrical accessory has decreased, (f) decreasing the engine RPM if the load of the electrical accessory decreased, (g) generating approximately 2,500 watts through an inverter generator to power the electrical accessories.

### DRAWINGS

FIG. 1A shows a perspective view of an ATV in an embodiment of the present teachings.

FIG. 1B shows a side profile view of a utility vehicle in an embodiment of the present teachings.

FIG. 1C shows a perspective view of an ATV in an embodiment of the present teachings.

FIG. 1D shows a perspective view of a snowmobile that can incorporate some embodiments of the present teachings.

FIG. 2 shows a cross-sectional view of an engine in an embodiment of the present invention.

FIG. 3 shows a perspective view of a stator in an embodiment of the present invention.

FIG. 4 shows a top view of an ATV depicting an inverter generator component layout in an embodiment of the present invention.

FIG. 5 shows a flow chart diagram of the operation within a control box for an inverter generator in an embodiment of the present invention.

FIG. 6 shows a flow diagram of the operation of an ATV with an inverter generator in an embodiment of the present invention.

FIG. 7 shows a switch assembly for an ATV with an inverter generator in an embodiment of the present invention.

### DESCRIPTION OF VARIOUS EMBODIMENTS

The following discussion is presented to enable a person skilled in the art to make and use embodiments of the invention. Various modifications to the illustrated embodiments will be readily apparent to those skilled in the art, and the generic principles herein may be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention. The following introductory material is intended to familiarize the reader with the general nature and some of the features of embodiments of the invention.

Although the description that follows is directed to an inline two cylinder, internal combustion engine, it should be noted that the invention is not limited to such. Instead, the features of the present invention may be applied to any type of internal combustion engine, as would be appreciated by those skilled in the art. For example, the features of the present invention may be applied to a single cylinder, v-type, opposed cylinder, multiple cylinder engine with more than two cylinders, or a rotary engine without deviating from the scope of the present invention.

In addition, while the engine of the present invention is specifically designed for use in an ATV, the present invention is not limited just to use on ATV's. To the contrary, the present invention may be used in any vehicle type, including cars, scooters, motorcycles, snowmobiles and other suitable vehicles.

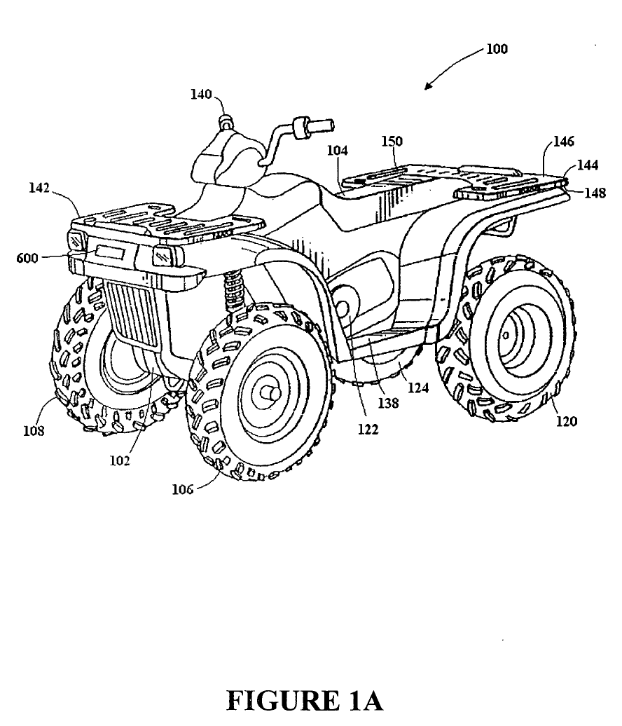

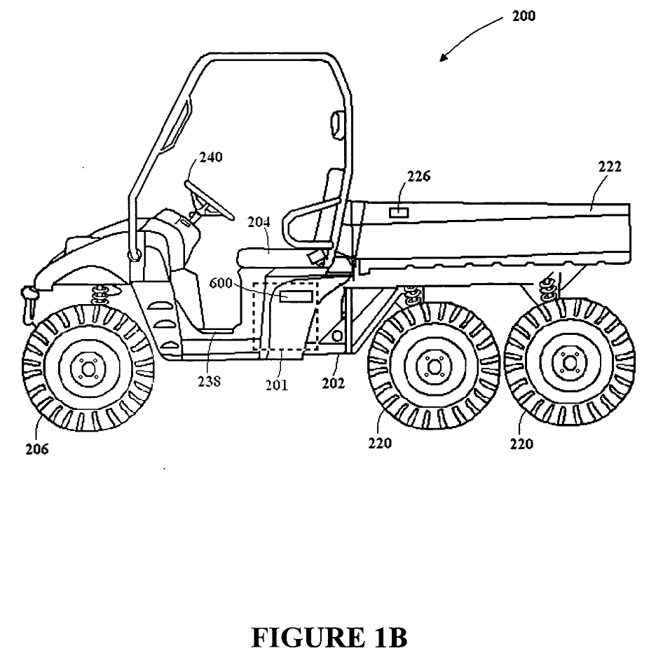

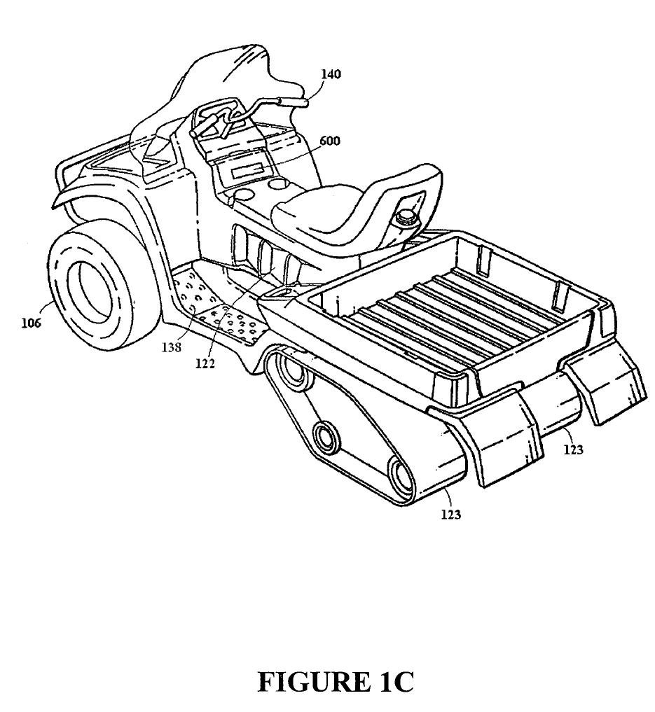

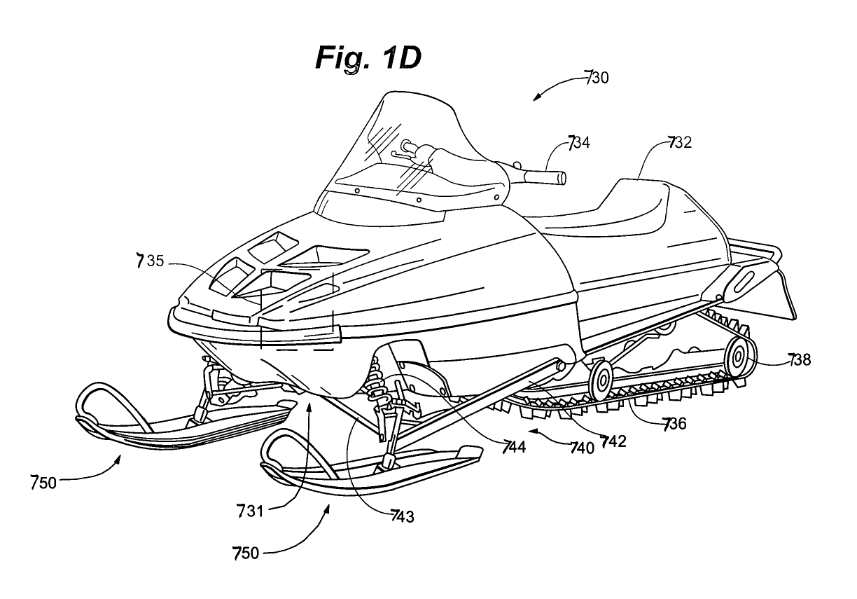

FIG. 1A is a perspective view of a vehicle 100 in accordance with an exemplary embodiment of the present teachings. Vehicle 100 of FIG. 1A can be generally referred to as an ATV. Vehicle 100 can have a chassis 102 carrying a straddle type seat 104. In FIG. 1A, straddle type seat 104 is sufficiently narrow to be straddled by a vehicle rider. Vehicle 100 can have a ground engaging member such as a left front wheel 106, a right front wheel 108, a left rear wheel 120, and right rear wheel 124. In some embodiments, vehicle 100 could have tracks 123 as shown in FIG. 1C. Vehicle 100 can also include an engine 122 that is carried by chassis 102. Engine 122 can be coupled to at least some wheels of vehicle 100 via a drive train for propelling vehicle 100. Engine 122 can be used to power each rear wheel 120 and 124, and in some cases also each front wheel 106 and 108. It is fully contemplated other devices such as a motor could be used to power vehicle 100 without departing from the spirit of the present teachings.

Vehicle 100 can also include a first footrest 138 that can be seen extending from one side of the chassis 102 in FIG. 1A. Vehicle 100 can also include a second footrest (not shown in FIG. 1A) that extends from the other side of chassis 102. Vehicle 100 also includes member 140 that may be used for steering vehicle 100. In FIG. 1A, steering member 140 comprises a handlebar. Vehicle 100 can also include at least one mounting aperture 150. For example, mounting aperture 150 can be located on accessory platforms 142 and 144 often referred to as racks. Accessory platforms 142 and 144 can have a top surface 146 and a bottom surface 148 coupled to chassis 102. Accessory platform 144 can have at least one mounting aperture 150 extending from top surface 146. It is fully contemplated mounting aperture 150 could be located anywhere on vehicle 100 such as chassis 102, the body of vehicle 100, and footrest 138 without departing from the spirit of the present teachings. Switch assembly 600 is also shown mounted to the front of vehicle 100 and operation of switch assembly 600 will be described in further detail below.

FIG. 1B is another perspective view of a vehicle in accordance with an embodiment of the present teachings. Vehicle 200 of FIG. 1B can be generally referred to as a utility vehicle. Vehicle 200 can have a chassis 202 carrying a bench type seat 204. In FIG. 1B, bench type seat 204 can be sufficiently wide to hold more than one vehicle rider. It is contemplated the embodiments for FIGS. 1A and 1B could have two seats, a seat large enough for two or more people to straddle, or side-by-side seating such as bucket style seats without departing from the spirit of the present teachings. Vehicle 200 can have a ground engaging member such as left front wheel 206, a right front wheel (not shown), left rear wheels 220 and right rear wheels (not shown). In some embodiments, vehicle 200 could have a single left and right rear wheel or tracks 123 similar to those shown in FIG. 1C. Vehicle 200 also includes an engine 201 that is carried by chassis 202. Engine 201 is preferably selectively coupled to at least two rear wheels of vehicle 200 via a drive train for propelling vehicle 200; however, engine 201 may be used to power any or all wheels on vehicle 200. It is fully contemplated that engine 201 could be a motor or any other apparatus to propel vehicle 200 without departing from the spirit of the present teachings.

Vehicle 200 can also include a footrest 238 that can be seen extending from one side of the chassis 202 to the other side. Vehicle 200 can also include at least one mounting aperture 226. For example, mounting aperture 226 can be located on accessory platform 222 often referred to as a box. Box 222 can extend from the rear of the chassis for carrying various items. Box 222 can have mounting apertures 226 similar to accessory platforms 142 and 144 located on the top of bed rail. It is further contemplated; box 222 could have mounting apertures located within box 222, without departing from the spirit of the present teachings. Vehicle 200 can also include member 240 that may be used for steering vehicle 200. In the embodiment of FIG. 1B, steering member 240 comprises a steering wheel. Vehicle 200 can also have an accessory platform mounted to the front of the vehicle. It is fully contemplated mounting aperture 226 could be located anywhere on vehicle 200 such as chassis 202, the body of vehicle 200, and footrest 238 without departing from the spirit of the present teachings. Switch assembly 600 is also shown mounted to the side of vehicle 200 and operation of switch assembly 600 will be described in further detail below.

FIG. 1D depicts a snowmobile of the teachings. Snowmobile 730 includes a chassis 731, a straddle type seat 732 mounted to the chassis 731, and a pair of handlebars 734 carried by the chassis 731 adjacent to the seat 732 so that a rider sitting in straddle fashion on the seat may steer the snowmobile using the handlebars 734. The snowmobile includes a ground engaging member such as an endless track 736 carried by a rear suspension system 738 mounted to the chassis 731, the endless track being connected to and powered by the snowmobile's engine 735 (typically located beneath the hood near the front of the snowmobile). A fuel tank may be located under seat 732.

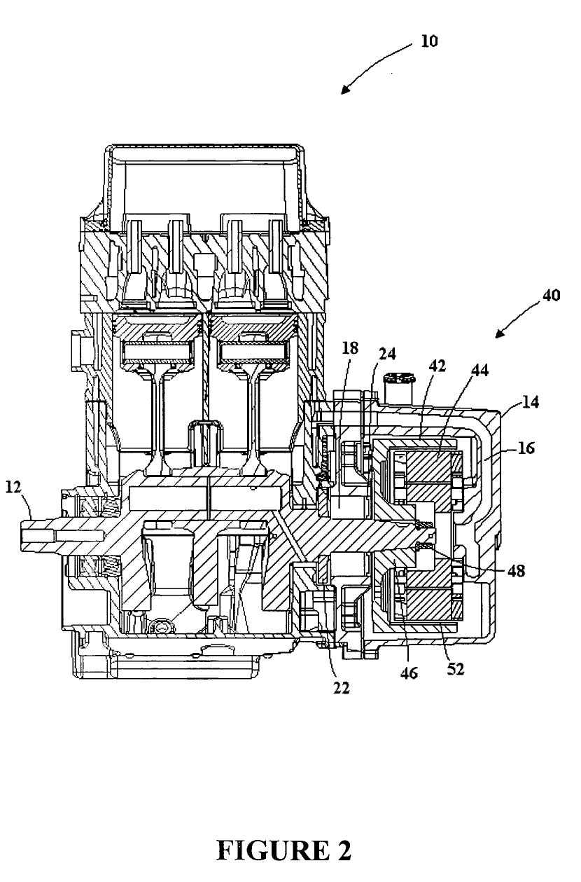

Other ground engaging members, left and right steerable skis 750 are carried by a front suspension system 740, which in turn is mounted to the chassis 731. The suspension system may be of any suitable type. In the drawings, a trailing arm suspension system is depicted, such a system utilizing, for each ski, a trailing arm 742 connected at its rear end to the chassis, a pair of generally transversely mounted radius rods 743 connected at their inner ends to the chassis and at their outer ends to the front end of the trailing arm, and a shock/spring combination 744 connected at one end to the chassis 731 and at the other end to the front end of the trailing arm 742. Other suitable suspensions could also be utilized, however, including, e.g., a double A-arm (sometimes called “double wishbone”) suspension or a telescopic strut suspension. With reference to FIG. 2, a cross-sectional view of an engine in an embodiment of the present invention is shown. Engine 10 is designed to be mounted preferably on frame 102 of ATV 100. Engine 10 includes a crankshaft 12 mounted transversely to a vertical plane disposed in the longitudinal direction of ATV 100. Engine 10 can be carbureted, however, the present invention is not meant to be limited solely to carbureted engines. To the contrary, it is contemplated that the engine 10 could be provided with any other type of fuel delivery system without departing from the scope of the present invention. It is contemplated that the engine 10 of the present invention could be provided with a suitable fuel injection system.

In the embodiments discussed below, an engine integrated portable supply feature is disclosed which will give the operator electrical power wherever they may travel to power most electrical tools, lights, and most other electrical equipment without the need to bring along a generator. The present invention discloses a generator having a flywheel and stator allowing the generator to produce roughly 2.5 KW (kilo-watts) of electrical power output.

The present invention discloses an integrated electrical power supply capable of supplying 120 V (volts) of AC (Alternating Current) external power to operate lights, small hand tools, appliances, and many other electrical accessories. Further, the generator is robust enough to continue maintaining vehicle electrical charging and operating power. The system, discussed in more detail below, is made up of a large magnetic flywheel and a large wound stator for generating approximately 2.5 KW of electrical power output. Also disclosed is an ICU (Inverter Control Unit) which communicates a signal to the ECU (Engine Control Unit), which in turn will tell the engine to accelerate up or down in engine rpm depending on the required output load to operate the electrical device that is plugged into the control panel. This system provides inexpensive mobile electrical power useful for, but not limited to remote applications. The integrated inverter system frees up storage and carrying capacity by eliminating the need to strap on a portable generator system and the needed fuel to run it.

With reference to FIG. 2, a cross sectional view of an engine and inverter generator in an embodiment of the present invention is shown. Engine 10 includes a generator 40. Generator 40 preferably is a permanently excited 3-phase generator in which a magnet wheel 42 rotates around stationary coils 44. The potential for generator failure is reduced because only the magnet wheel 42 rotates, not the coil 44. In addition, maintenance and repair time for the generator 40 may be significantly reduced. Also, the weight of the rotating masses (i.e., the magnet wheel 42) can be reduced, which reduces the overall bending torque generated by the engine 10 which can directly have an affect on engine vibration.

Magnet wheel 42 is constructed as a forged part and is attached to the crankshaft 12 at hub 46. The hub 46 is mounted onto a tapered portion of the crankshaft 12 and secured there by a nut 48. While the magnet wheel 42 can be connected to the crankshaft 12 in this manner, it is contemplated that the magnet wheel 42 could be connected to the crankshaft in any number of alternate ways without deviating from the scope of the present invention.

As discussed above, crankshaft 12 being rotated by engine 10 and is operatively connected to gear 22. Gear 22 is the engine drive gear and may be utilized for driving any engine auxiliary component, such as an oil pump, coolant pump, cam shaft or balance shaft. It may also be used to operatively connect to the starter motor for providing starting operation of engine 10. Bearing 18 is located between gear 22 and seal 24 which prevents any oil from the engine side getting into the generator 40. Bearing 18 provides additional support to counterbalance the additional weight of the enlarged flywheel. Seal 24 is adjacent to the hub 46 of the flywheel 42. Flywheel 42 is much larger from the typical design to create additional power to run attached accessories. Flywheel 42 has an increased diameter from the common diameter of 125 mm to 200 mm. Flywheel 42 also has an increased width from the common width of 53 mm to 75 mm. This additional diameter and width adds additional weight to flywheel 42 increasing its weight from 6.25 lbs to 9.8 lbs. The increased weight and diameter create several adversities. First the additional weight creates a rotational balance issue, and thus the need for bearing 18 to counteract the balance problem. Second, the increased size of the flywheel creates a heat generation issue due to the amount of current generated by the generator.

Adjacent to flywheel 42 is stator 44. Stator 44 is enlarged as well from a common diameter of 108 mm to 160 mm. Stator 44 also has an increased width from the common width of 46 mm to 55 mm. Due to the increased power generation of the enlarged flywheel and stator, they also generate more heat thus requiring additional cooling. Stator 44 is encased in generator 40 with cover 14. Cover 14 has coolant lines 16 which encircle outer cover 14. Coolant from the engine's coolant system runs through lines 16 to remove heat generated by generator 40. Mounting the stator 44 directly to the stator cover 14 allows for better heat dissipation of the stator 44 due to increasing the amount conduction through the stator cover 14. Furthermore, cooling lines 16 are strategically positioned within the stator cover 14 to maximize the heat transfer by increasing the surface area of the common wall of stator cover 14 between the stator 44 and cooling line 16, as well as, minimizing the wall thickness of this common wall area. It is understood that cooling line 16 obtains it's coolant from the ATV's coolant system, which are well known in the art, and are typically comprised of a closed loop cooling circuit in which a coolant pump circulates fluid through passageways of the engine where the fluid is heated and is then routed to an external heat exchanger (e.g., radiator) where the heat is dissipated.

In prior generator systems, the stator has also been known to mount directly to the engine. The crankshaft would pass through the center of the stator and the flywheel would be mounted in a cupped fashion facing towards the center of the engine. This arrangement takes the mass of the flywheel and puts it out on the end of the crankshaft. However, this design is less than desirable for the large flywheel of the present invention. An increased flywheel size would add weight and create bending and torsional stresses to the crankshaft. Therefore, in the present embodiment, the flywheel is preferably rotated 180 degrees so that the bulk of the mass in the hub 46 is close to the bearing support 18 of the crankshaft 12 and the cup of the flywheel is faced outward. This design allows for having a heavier flywheel and/or a smaller bearing support as the rotating mass of the inverter generator is moved closer to a supporting member of the engine (i.e., the bearing) thus reducing the bending moment on the crankshaft. Additionally, by switching the positions of the stator and flywheel such that they are flip-flopped compared to prior-art engines, the manufacturability of the engine is improved as the rotating components of the engine are more centralized.

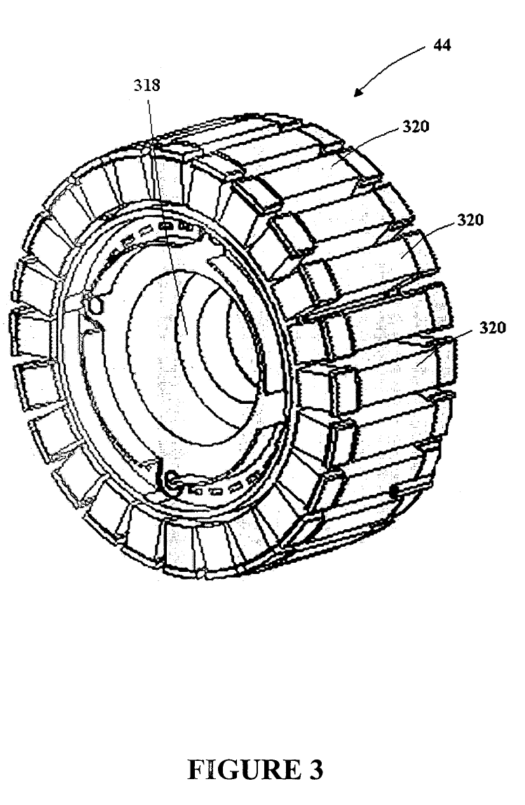

With reference to FIG. 3, a perspective view of a stator in an embodiment of the present invention is shown. As can be seen from FIG. 3, stator 44 has a step 318 which allows stator 44 to draw additional heat out of generator 40. Step 318 allows for a larger common wall surface area between the stator 44 and cooling lines 16. Generally, the inner diameter of stator 44 is 60 mm and step 318 has an even narrower diameter of 42 mm. The diameter maximizes the surface area between cooling lines in stator cover 14 and stator 44 for improved heat transfer. The coils of stator 44 are shown as reference number 320.

In operation, the rotation of crankshaft 12 turns flywheel 42. As stated above, stator 44 remains immobile while magnets 52 located on flywheel 42 spins about coils 320 of stator 44, which creates electricity. It is noted that even though flywheel 42 and stator 44 are larger, the overall weight of the vehicle when weighted down with a portable generator is decreased by approximately 90 lbs. That is to say that the present invention not only eliminates the need to carry a portable generator while maintaining the ability to produce the electricity of a portable generator, but the overall weight of the vehicle is only minimally increased. Therefore, even though the weight of the vehicle has increased, it is now easier for the operator to traverse the terrain and carry more items. For example, the operator can carry more accessories because they don't have a generator on the vehicle.

As stated above, this generator is unique in that it has a much larger flywheel and stator than traditional ATV generators. Further, the generator has a water-cooled outer stator cover to maintain and cool the stator to keep it from over heating. The system also has a power control panel for power distribution and monitoring system performance. In operation, the operator will place the vehicle in a stationary gear (e.g., neutral or park), start the vehicle, plug an electrical accessory into the control panel, and turn an inverter generator switch to inverter mode. The unit can have a load sensing system incorporated into the inverter generator control unit which will control and vary the engine rpm (roughly between 2000 to 4300 rpm as the electrical load demand increases or decreases). Thus, ATV 100 now becomes a combined vehicle and portable generator system.

Typical ATV generators can generate roughly 500 watts of DC (Direct Current). While this is enough to provide for the vehicle, it is not enough to support other accessories. The present invention proposes a larger generator and inverter capable of providing 2,500 watts of AC (Alternating Current) with a surge of 3000 watts of AC. This increased power generation allows for the 500 watts of DC to run the vehicle and by use of an inverter control box converts 2,500 watts of AC for operation of additional accessories (e.g., work tools). While the enlarged size of generator 40 provides some packaging obstacles, the inventors have found that these obstacles are minimal. For example, the packaging adjustments are minimal to the vehicle packaging, for example, the brake lever on the right hand side might need to be moved out or bent a bit to route around the stator cover 14. Additionally, a switch assembly 600 (discussed in more detail below) has been added to the front of ATV 100.

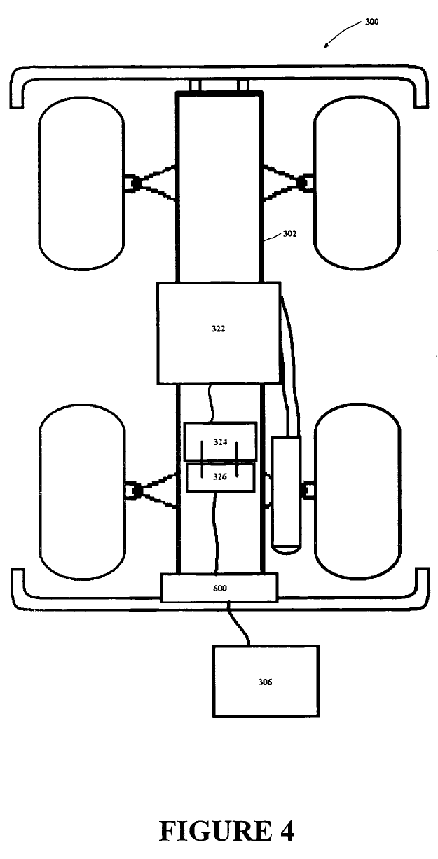

1 In another embodiment, with reference to FIG. 4, ATV 300 is shown. ATV 300 includes engine and inverter generator 322 mounted to ATV frame 302. ATV 300 also includes switch assembly 600 that allows the transfer of power from engine and inverter generator 322 to one or more external accessories 306 that may be plugged into switch assembly 600 located at the back of the ATV 300. ATV 300 additionally includes ICU (Inverter Control Unit) 326 and ECU (Engine Control Unit) 324. The ICU is a control box for the inverter generator that is able to convert DC power to an AC output, sense the load requirement on the inverter generator, and regulate the power output to one or more external accessories 306. The ECU 324 controls the base vehicle and engine operations, including the fuel system and the ignition system. In some embodiments the ICU may be integral with the ECU.

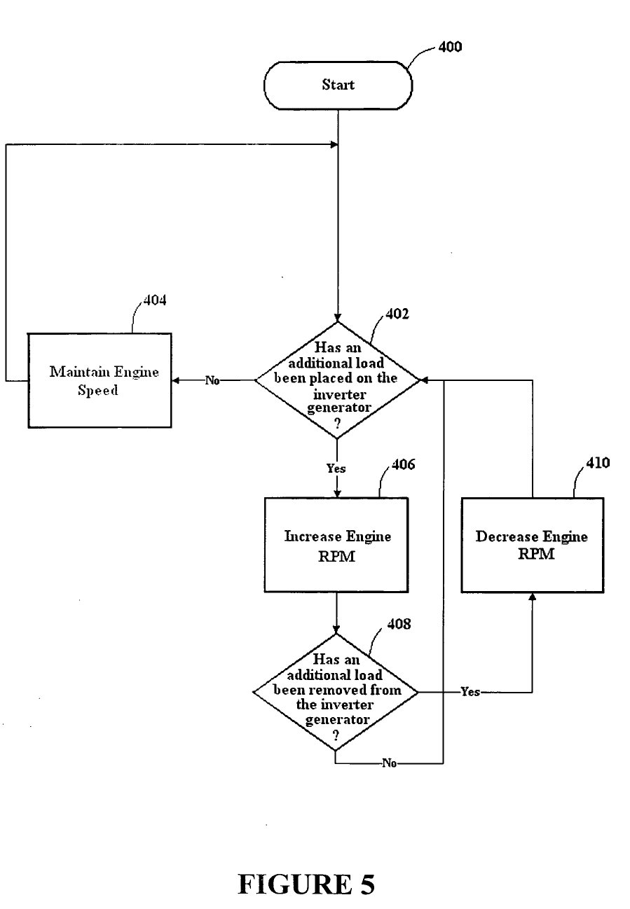

With reference to FIG. 5, a flow chart diagram of the operation within an ICU 326 for an inverter generator in an embodiment of the present invention is shown. At inverter operation state 400 ATV 300 has been put into an advanced inverter generator mode though a switch 602 (FIG. 8) flipped by the operator. At state 402, ICU 326 makes a determination as to whether an additional load, such as from an external accessory 306 that has been plugged into switch assembly 600 of ATV 300, has been placed on engine and inverter generator 322. The amount of load can be measured simply by a voltage sensor or can be determined based on other engine operating parameters such as intake airflow and pressure. If no additional load has been placed on engine and inverter generator 322, then engine and inverter generator 322 will maintain engine speed normally at state 404 as instructed by the ICU 326, which works in collaboration with the ECU 324. The program then returns once again to state 402 to determine if an additional load has been placed on the engine and inverter generator 322. If an additional load has been placed on the engine and inverter generator 322, ICU 326 sends a signal to the ECU 324 to increase the engine RPM at state 406, thus providing more power to operate the additional load/accessory. The program then proceeds to inquire as to whether the additional load has been removed at state 408. If the load has been removed, the program advances to state 410 and decreases the engines RPM based upon the size of the load removed. If an additional load has not been removed the program returns to state 402 to determine if an additional load has been placed on the engine and inverter generator 322. This program repeats this process until the operator flips the switch 602 and takes ATV out of inverter generator mode. The ICU 326 also is able to determine whether an accessory load requirement is too large for the engine and inverter generator to operate. For instance, if the load requirement of the external accessory 306 is larger than 2500 watts, the ICU may signal the ECU to go into safe mode or shutdown the engine so that the external accessory is not damaged due to insufficient power.

An additional change in traditional ATV structure is the need to increase the gauge size wiring to handle the additional current generated by inverter generator 322 of the present invention. However, during normal operation, ATV generator 322 will produce 500 watts which is plenty to power ATV 300 during operation. That is to say certain coils of the stator 44 are solely set aside for running the vehicle and certain coils are dedicated to supplying power to external accessories 306. Therefore, the power output from a predetermined number of the coils 320 is directly connected to the battery, while the output of the remaining coils are branched to the ICU to convert the DC power to AC such that it may be fed to the external accessories 306.

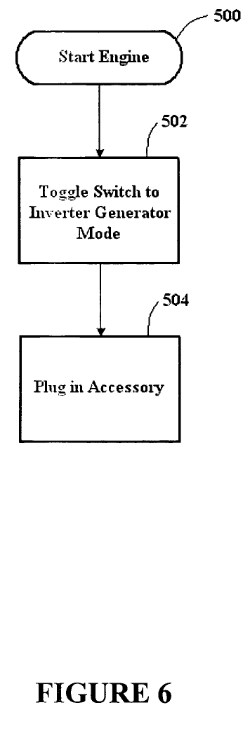

With reference to FIG. 6, a flow diagram of the operation of an ATV with an inverter generator in an embodiment of the present invention is shown. In operation, the operator would first turn on the ATV at state 500. Thus ATV 300 is in the parked or neutral geared position so that the ATV remains in a stationary position. Additionally, a vehicle brake system, which are well known in that art, may be engaged to further make certain that the ATV is not mobile during starting. Next the operator would toggle the inverter switch 602 to the inverter generator mode as discussed above at state 502. After which the operator would be able to plug accessories into ATV 300 at state 504. ATV 300 can power the operation of an infinite number of accessories as long as the engine and inverter generator 322 is configured to provide the load required by the accessories (e.g., 2500 Watts). It is further contemplated that the inverter generator is configured to not power any accessories unless the transmission remains in the neutral or parked gear, as well as, possibly requiring that the vehicle braking system be engaged during operation of any accessories.

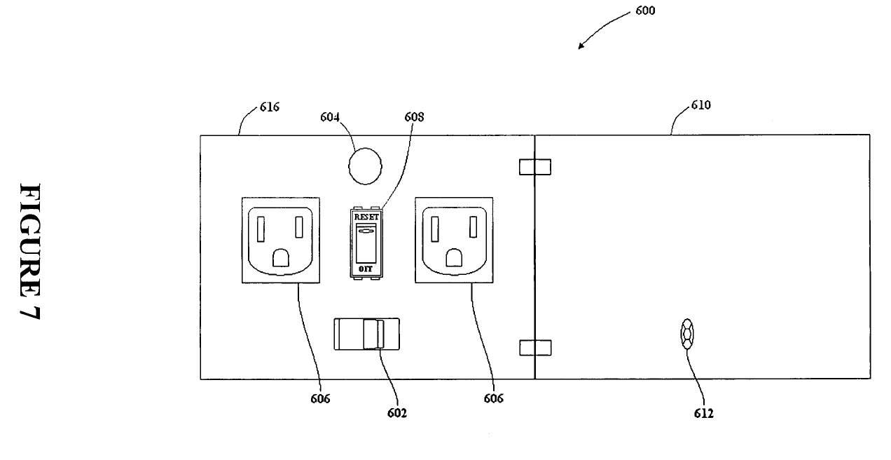

With reference to FIG. 7, a switch assembly for an ATV with an inverter generator in an embodiment of the present invention is shown. Switch assembly 600 could be located anywhere on ATV 100 without departing from the spirit of the invention; however, for purposes of this discussion switch assembly 600 is located on the front of ATV 100. This configuration has the added benefit that the switch assembly 600 is mounted in front of the vehicle headlight for increased visibility when dark. As discussed above, inverter switch 602 is moved to the on position by the operator when operation of external accessories is desired. In some embodiments, the ATV 100 may not be started if switch 602 is in the on position. In other embodiments, despite movement of the switch 602 the inverter generator may not power external accessories unless the vehicle is placed in a parked or neutral gear and/or the vehicle brake is in the engaged position so that the vehicle is held in a stationary position. Utility outlets 606 provide power connections so the operator can plug in electrical accessories. Breaker switch 608 allows the operator to reset the inverter generator system should a breaker open due to a power surge. Operation light 604 can be lit during operation and extinguished when inverter mode switch 602 is turned off. Lid 610 is used to protect utility outlets 606 from dirt, water, snow, and other elements often encountered during operation of ATV 100. In some embodiments, the switch assembly 600 may include a seal such that when lid 610 is closed the seal assists in protecting the switch assembly 600. An automatic shutoff switch 612 automatically stops the ATV from being in inverter generator mode by turning inverter generator mode switch 602 to the off position, when lid 610 is shut over control panel 616.

Thus, embodiments of the MOBILE INVERTER GENERATOR are disclosed. One skilled in the art will appreciate that the present invention can be practiced with embodiments other than those disclosed. The disclosed embodiments are presented for purposes of illustration and not limitation, and the present invention is limited only by the claims that follow.

1. A vehicle, comprising:
a chassis;
at least one front ground engaging member and at least one rear ground engaging member coupled to the chassis;
a steering member for steering at least one of the ground engaging members;
an engine carried by the chassis for powering the vehicle, the engine including a cylinder disposed adjacent a crankshaft and an inverter generator operatively connected to the crankshaft;
an output shaft operatively coupled to the crankshaft to transmit power from the engine to at least one of the ground engaging members, and
a switch that has a first position and a second position, wherein the switch prevents accessories from being powered by the inverter generator when the engine is providing power to one of the ground engaging members.

2. The vehicle of claim 1, wherein the inverter generator can produce approximately 2,500 watts.

3. The vehicle of claim 1, wherein the inverter generator can produce greater than 60 volts.

4. The vehicle of claim 1, wherein the inverter generator includes a flywheel and stator operatively coupled to the crankshaft.

5. The vehicle of claim 4, wherein the inverter generator flywheel has a diameter greater than 150 mm.

6. The vehicle of claim 1, wherein electrical accessories can be plugged into the vehicle.

7. The vehicle of claim 6, wherein engine RPM can be increased in response to the electrical accessories plugged into the vehicle.

8. The vehicle of claim 6, wherein engine RPM can be decreased in response to the electrical accessories being un-plugged from the vehicle.

9. The vehicle of claim 7, wherein the engine RPM may vary between 2000 and 4500 RPM.

10. The vehicle of claim 1, wherein the ground engaging member is selected from a group consisting of a wheel, track, or ski.

11. The vehicle of claim 1, further comprising a cover attached to the engine adjacent to the inverter generator, a cooling line disposed within the cover, and a fluid within the cooling line such that heat is transferred from the inverter generator to the fluid.

12. A vehicle comprising:
an engine;
a transmission coupled to the engine;
at least one ground engaging member;
an output shaft selectively coupled to the transmission to transmit power from the engine to the at least one ground engaging member;
an inverter generator operatively coupled to the engine to transmit power to an electrical accessory; and
a control system that selectively controls the speed of the engine in response to the electrical accessory.

13. The vehicle of claim 12, wherein engine speed is increased in response to increased load of the electrical accessory.

14. The vehicle of claim 12, wherein engine speed is decreased in response to decreased load of the electrical accessories.

15. The vehicle of claim 12, wherein the control system does not control the speed of the engine when the output shaft is coupled to the transmission.

16. The vehicle of claim 12, wherein the ground engaging member is selected from a group consisting of a wheel, track, or ski.

17. The vehicle of claim 12, further comprising a vehicle brake selectively engaged to keep the ground engaging member stationary.

18. The vehicle of claim 17, wherein the control system does not control the speed of the engine when the brake is not engaged.

19. The vehicle of claim 12, further comprising a control panel including a switch that has a first position and a second position, wherein the control system does not control the speed of the engine when the switch is in the first position.

20. The vehicle of claim 19, further comprising a control panel lid that can be moved between an open and closed position, wherein the switch is automatically moved to the first position when the control panel lid is closed.

21-25. (canceled)
